(19) United States
(12) Patent Application Publication
(10) Pub. No.: US 2009/0051969 A1
(43) Pub. Date: Feb. 26, 2009

(54) TERMINAL APPARATUS, IMAGE FORMING APPARATUS, AND PRINTING SYSTEM HAVING THE SAME, AND PRINTING METHOD THEREOF

(75) Inventor: Hyung-jae YOO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/169,162

(22) Filed: Jul. 8, 2008

(30) Foreign Application Priority Data
Aug. 24, 2007 (KR) 2007-85657

(51) Int. Cl. G06F 15/00

(52) U.S. Cl. 358/1.16

(57) ABSTRACT

A terminal apparatus includes an interface unit connected to an image forming apparatus, and a controller to convert a file into print data page by page before a file print command is input and to transmit the converted print data to the image forming apparatus when a preset event occurs in the file. Therefore, a user prepares a document which is highly likely to be printed, so that a print delay time may be reduced and a printing speed may increase.

### CROSS-REFERENCE TO RELATED APPLICATIONS

This application claims priority under 35 U.S.C. §119 (a) of Korean Patent Application No. 10-2007-0085657, filed on Aug. 24, 2007, in the Korean Intellectual Property Office, the disclosure of which is incorporated herein by reference in its entirety.

### BACKGROUND OF THE INVENTION

1. Field of the Invention

The present general inventive concept relates to a terminal apparatus, an image forming apparatus and a printing system having the same, and a printing method thereof. More particularly, the present general inventive concept relates to a terminal apparatus to generate print data before a user inputs a print command and to transmit the generated print data to an image forming apparatus which receives the generated print data, and a printing system having the same, and a printing method thereof.

2. Description of the Related Art

An image forming apparatus generally prints print data provided from a terminal apparatus, such as a computer, onto a recording medium. Examples of such image forming apparatuses include copiers, printers, facsimile machines or multifunction peripherals (MFPs) which combine functions of copiers, printers and facsimile machines into a single system.

In this image forming apparatus, a considerable amount of time is required to perform printing, to operate the terminal apparatus, such as a computer, to launch various application programs used to generate print data, to convert the print data into languages which the image forming apparatus is able to interpret, and to transmit the print data to the image forming apparatus.

FIG. 1 is a flowchart illustrating a conventional document printing method.

In FIG. 1, a user may write or edit an original document using an application program, for example, a Word processor, using a personal computer (PC) in operation S10.

After the original document is completely written, the user may apply a print command in operation S20. In response to the print command applied by the user, a printer driver may convert the original document into data which an image forming apparatus is able to interpret, such as Printer Control Language (PCL) or PostScript (PS), in operation S30, and may transmit the converted data to the image forming apparatus in operation S40. The image forming apparatus may then start printing using the received data in operation S50. Accordingly, in order to obtain desired prints in response to the print commands input by the user, time is required to perform printing, convert the original document into data, and transmit the converted data to the image forming apparatus. Additionally, the greater the size of the original document, the greater the time that is required for conversion and transmission of data. Therefore, the time required to output a document may gradually increase.

### SUMMARY OF THE INVENTION

The present general inventive concept provides a terminal apparatus, an image forming apparatus and a printing system having the same, and a printing method thereof, in which a user prepares a document which is highly likely to be printed, so that a print delay time may be reduced and a printing speed may increase.

The present general inventive concept also provides a terminal apparatus, an image forming apparatus, a printing system having the terminal apparatus and the image forming apparatus, and a printing method thereof, which enables a printing speed to be increased and effectively manages resources of the image forming apparatus when the image forming apparatus is connected to a network.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a terminal apparatus including an interface unit connected to an image forming apparatus, and a controller to convert a file into print data page by page before a file print command is input and to transmit the converted print data to the image forming apparatus when a preset event occurs in the file.

If the file print command is input, the controller may cause the image forming apparatus to perform printing using the pre-transmitted print data.

The controller may check whether the image forming apparatus is able to receive the print data.

The terminal apparatus may further include a storage unit. If it is determined that the image forming apparatus is unable to receive the print data, the controller may store the print data converted page by page in the storage unit.

If the file is closed before the file print command is input, the controller may cause the image forming apparatus to remove the pre-transmitted print data of the file.

If the file is edited before the file print command is input, the controller may convert an edited portion of the file into print data and may transmit the converted data to the image forming apparatus.

The foregoing and/or other aspects and utilities of the present general inventive concept may also be achieved by providing an image forming apparatus including an interface unit connected to a terminal apparatus, a storage unit to store print data, which is converted page by page from a file and is transmitted from the terminal apparatus, and a controller to cause the prestored print data of the file to be printed if a file print command is received via the interface unit.

If the terminal apparatus inquires whether the image forming apparatus is able to receive the print data, the controller may notify the terminal apparatus of the possibility to receive the print data.

If a command to delete the prestored print data of the file is received from the terminal apparatus, or if the preset time has elapsed after the print data of the file is stored in the storage unit, the controller may delete the print data stored in the storage unit.

If print data corresponding to an edited portion of the file is received from the terminal apparatus, the controller may update the print data corresponding to the edited portion from among the print data stored in the storage unit.

The foregoing and/or other aspects and utilities of the present general inventive concept may also be achieved by providing a printing system including a terminal apparatus to convert a file into print data page by page before a file print command is input and to transmit the converted print data to an image forming apparatus when a preset event occurs in the file; and an image forming apparatus to receive the print data from the terminal apparatus and to store the received print data, and to perform printing using the prestored print data of the file if the file print command is input.

The foregoing and/or other aspects and utilities of the present general inventive concept may also be achieved by providing a printing method in a terminal apparatus, the method including determining whether a preset event occurs in a file; if it is determined that the preset event occurs in the file, converting the file into print data page by page before a file print command is input; and transmitting the converted print data to an image forming apparatus.

The method may further include causing the image forming apparatus to perform printing using the pre-transmitted print data, if the file print command is input.

The method may further include checking whether the image forming apparatus is able to receive the print data.

The method may further include causing the image forming apparatus to remove the pre-transmitted print data of the file, if the file is closed before the file print command is input.

The method may further include converting an edited portion of the file into print data and transmitting the converted data to the image forming apparatus, if the file is edited before the file print command is input.

The foregoing and/or other aspects and utilities of the present general inventive concept may also be achieved by providing a printing method in an image forming apparatus, the method including receiving print data converted page by page from a file from a terminal apparatus and storing the received print data; and if a file print command is received from the terminal apparatus, printing the prestored print data of the file.

The method may further include notifying the terminal apparatus of the possibility to receive the print data, if the terminal apparatus inquires whether the image forming apparatus is able to receive the print data.

The method may further include deleting the print data stored in the storage unit, if a command to delete the prestored print data of the file is received from the terminal apparatus, or if the preset time has elapsed after the print data of the file is stored in the storage unit.

The method may further include updating print data corresponding to an edited portion from among the print data stored in the storage unit, if the print data corresponding to the edited portion of the file is received from the terminal apparatus.

The foregoing and/or other aspects and utilities of the present general inventive concept may also be achieved by providing a computer-readable medium to contain computer-readable codes as a program to execute a printing method in a printing system having a terminal apparatus, the method including determining whether a preset event occurs in a file, if it is determined that the preset event occurs in the file, converting the file into print data page by page before a file print command is input, and transmitting the converted print data to an image forming apparatus

The foregoing and/or other aspects and utilities of the present general inventive concept may also be achieved by providing a computer-readable medium to contain computer-readable codes as a program to execute a printing method in a printing system having an image forming apparatus, the method including receiving print data converted page by page from a file from a terminal apparatus and storing the received print data, and if a file print command is received from the terminal apparatus, printing the prestored print data of the file.

The foregoing and/or other aspects and utilities of the present general inventive concept may also be achieved by providing a printing system including a terminal apparatus having a controller to automatically convert a file into print data and to transmit the converted print data to an external apparatus, without a file print command when a preset event occurs in the file.

The foregoing and/or other aspects and utilities of the present general inventive concept may also be achieved by providing a printing system including an image forming apparatus having a storage unit, and a controller to receive print data without a file print command, to control the storage unit to store the received print data, and to print the stored print data when the file print command is received.

The foregoing and/or other aspects and utilities of the present general inventive concept may also be achieved by providing a printing system including a terminal apparatus having a controller to automatically convert a portion of a file into print data and to transmit the converted print data to an external apparatus, without converting an entire portion of the file into entire print data and transmitting the entire print data of the file, when a preset event occurs in the portion of the file.

The foregoing and/or other aspects and utilities of the present general inventive concept may also be achieved by providing a printing system including an image forming apparatus having a storage unit, and a controller to control the storage unit to store print data of an entire portion of the file, to receive another print data of a portion of the file, and to update the stored print data of the entire portion of the file with the another print data of the portion of the file.

The foregoing and/or other aspects and utilities of the present general inventive concept may also be achieved by providing a printing system including an image forming apparatus having a controller to separately receive first print data of an entire portion of the file, second print data of a portion of the file, and a file print command, and to print an image according to the first print data of the entire portion of the file and the second print data of the portion of the file when the file print command is received.

The foregoing and/or other aspects and utilities of the present general inventive concept may also be achieved by providing a printing system including a terminal apparatus having a controller to convert a file into print data and to transmit the converted print data to an external apparatus, when a preset event occurs in the file, and to transmit a file print command separately from the converted print data.

The foregoing and/or other aspects and utilities of the present general inventive concept may also be achieved by providing a printing system including an image forming apparatus having a controller to separately receive print data and a file print command at a time interval, and to print the print data according to the separately received file print command.

The foregoing and/or other aspects and utilities of the present general inventive concept may also be achieved by providing a printing system including an image forming apparatus having a storage unit, and a controller to receive print data without a file print command, to control the storage unit to store the received print data, and to print the stored print data when the file print command is received.

The foregoing and/or other aspects and utilities of the present general inventive concept may also be achieved by providing a printing system including a terminal apparatus having a controller to convert one of a plurality of units of a file into print data and to transmit the print data to an external apparatus, when a preset event occurs in the one unit of the file, and to transmit a file print command separately from the print data to print the file with the transmitted print data.

The foregoing and/or other aspects and utilities of the present general inventive concept may also be achieved by providing a printing system including a terminal apparatus having a controller to convert a first unit of a file into first print data and to transmit the first print data to an external apparatus when a preset event occurs in the first unit of the file, to convert a second unit of the file into second print data and to transmit the second print data when a second preset event occurs in the second unit of the file, and to generate a file print command to print the file using the first print data and the second print data.

The foregoing and/or other aspects and utilities of the present general inventive concept may also be achieved by providing a printing system including an image forming apparatus having a controller to receive first print data corresponding to a first unit of a file from an external apparatus, to separately receive second print data corresponding to a second unit of the file, and to receive a file print command.

The image forming apparatus may include a storage unit to store the file and to update the file with the first print data and the second print data, and the controller to print an image corresponding to the updated file according to the file print command.

The image forming apparatus may include a printing device to be in a stand-by state to prepare a printing operation when the controller receives at least one of the first print data and the second print data.

The printing device may be changed from the stand-by state to the printing operation when the controller receives the file print command.

The printing device may perform the printing operation when the controller receives the file print command.

The file may include a plurality of units including the first unit and the second unit, and one or more remaining units of the file may not be received when the first print data and the second print data are received.

The first unit of the file may include a page of the file, and the second unit of the file may include another page of the file. A printing system comprising:

The foregoing and/or other aspects and utilities of the present general inventive concept may also be achieved by providing a printing system including an image forming apparatus connectable with a first terminal apparatus and a second terminal apparatus to receive first print data of a first file without a first file print command from the first terminal apparatus, to receive second print data of a second file without a second file command from the second terminal apparatus, and to print an image corresponding to one of the first file and the second file according to a corresponding one of the first file print command and the second file print command.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flowchart illustrating a conventional document printing method;

FIG. 2 is a block diagram illustrating a printing system according to an exemplary embodiment of the present general inventive concept;

FIG. 3 is a block diagram illustrating a terminal apparatus according to an exemplary embodiment of the present general inventive concept;

FIG. 4 is a block diagram illustrating an image forming apparatus according to an exemplary embodiment of the present general inventive concept;

FIG. 5 is a flowchart illustrating a print file management method according to an exemplary embodiment of the present general inventive concept; and

FIG. 6 is a flowchart illustrating a printing method according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

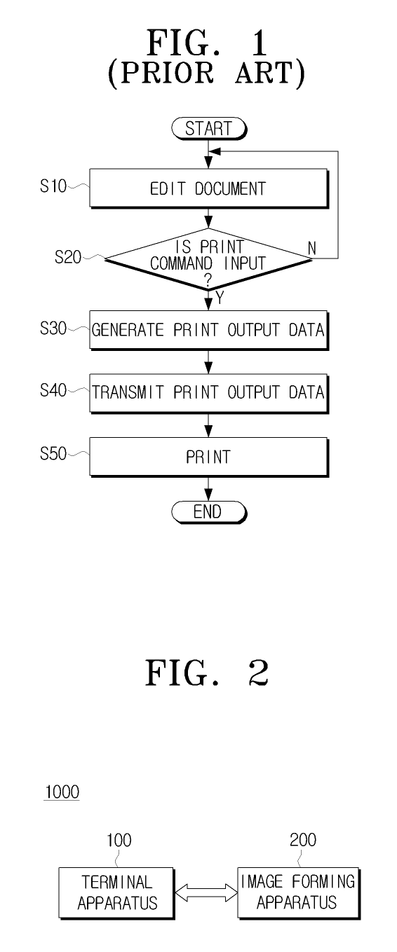

FIG. 2 is a block diagram illustrating a printing system 1000 according to an exemplary embodiment of the present general inventive concept.

The printing system 1000 of FIG. 2 includes a terminal apparatus 100 and an image forming apparatus 200.

The terminal apparatus 100 may convert a file which is highly likely to be printed into print data page by page, and may transmit the converted print data to the image forming apparatus 200.

Here, the terminal apparatus 100 may be in a mode to convert the file into the print data without a command input by a user to convert the file into the print data, and/or to transmit the converted print data to an external apparatus, such as the image forming apparatus 200, without a command input by a user to transmit the print data to the external apparatus. When the terminal apparatus 100 is in the mode, the file has a high possibility to be printed, so that the file is converted and transmitted to the external apparatus without a command to convert the file into the print data and/or to transmit the print data to the external apparatus.

When the file has one or more pages each as a unit, and when the terminal apparatus processes data of each page or performs a process on each page, each page is each page may be converted into the print data as a unit of data. The print data as the unit of the data is transmitted to the external apparatus. However, the present general inventive concept is not limited thereto. The file may include one or more different units from the unit of page. Accordingly, the file can be converted into the print data unit by unit.

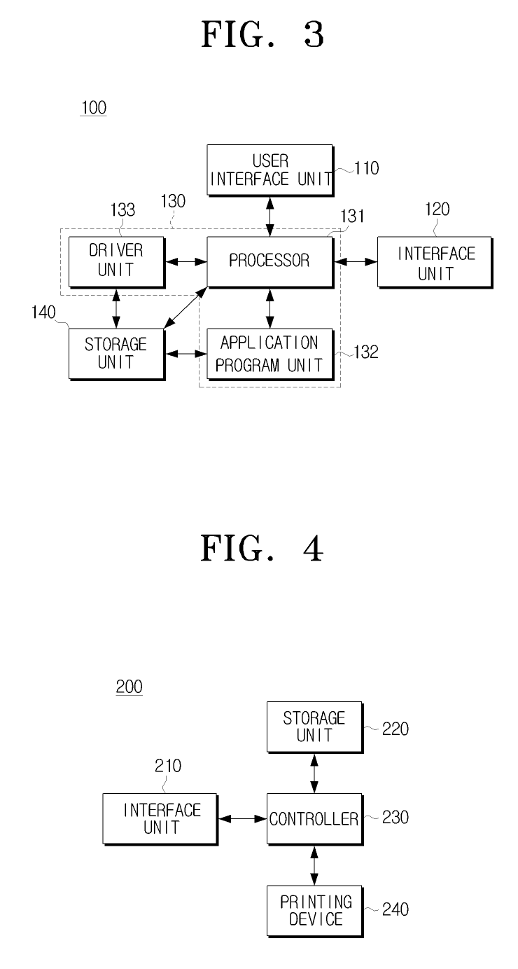

FIG. 3 is a block diagram illustrating the terminal apparatus 100 of FIG. 2 according to an exemplary embodiment of the present general inventive concept.

Referring to FIGS. 2 and 3, the terminal apparatus 100 includes a user interface unit 110, an interface unit 120, a controller 130, and a storage unit 140.

The file which is highly likely to be printed and to which the present general inventive concept is applicable may be a document file which a user edits or confirms before printing, for example a document which is currently being edited or displayed on the terminal apparatus 100. The file may be a file created using, for example, a word processor which the user frequently uses, or a specific program file or a specific format file. The file may alternatively be any printable file, such as an image file, a file in portable document format (PDF) or a presentation file.

The terminal apparatus 100 is capable of at least editing the file corresponding to the print data, and is capable of instructing the image forming apparatus 200 to perform printing. The terminal apparatus 100 may be implemented as a personal digital assistant (PDA), a mobile phone, a digital camera, a digital video camera, a point of sale (POS) terminal, a personal computer (PC), etc.

The user interface unit 110 may receive edit information of a document to be printed, and print status information. Specifically, the user interface unit 110 may receive user commands to execute various functions of the terminal apparatus 100, and data that is used to generate the print data using various application programs, or may display a user interface window for various application programs, a user interface window for a printer driver, or other windows. For example, if a computer is used as the terminal apparatus 100, a keyboard or a mouse, or a cathode ray tube (CRT) or a liquid crystal display (LCD) monitor may function as the user interface unit 110. The document may be created or edited by manipulation of the user interface unit 110 and/or the controller 130.

The interface unit 120 may be connected to the image forming apparatus 200, and may provide the image forming apparatus 200 with the generated print data. In more detail, the interface unit 120 enables the terminal apparatus 100 to be connected to an external apparatus, and may be implemented as a parallel port, a universal serial bus (USB) port or a wireless module. If a computer is used as the terminal apparatus 100, the interface unit 120 may be connected to a printing apparatus, such as a printer, so that a document created by the computer may be transmitted to the printing apparatus through the interface unit 120.

The storage unit 140 may store the print data. The storage unit 140 may include a non-volatile memory to store an operating system required to drive the terminal apparatus 100, and a volatile memory to temporarily store data generated during the launch of various application programs and data required to perform printing.

The volatile memory of the storage unit 140 may store the print data to be transmitted to the image forming apparatus 200, and may also store a print profile supported by the image forming apparatus 200. Here, the print profile may include information regarding a scaling ratio when performing functions to change the paper size and print or zoom in and out functions, data for setting coordinates of start and end points of the print data according to the size of paper, or commands converted into languages which the image forming apparatus 200 is able to interpret to perform printing based on the above information.

If a preset event occurs in a file, the controller 130 may convert the file into print data page by page prior to input of a command to print the file, and may transmit the converted print data to the image forming apparatus 200. The controller 130 includes a processor 131, an application program unit 132 and a driver unit 133.

The preset event may be a change or addition to the file in a mode to automatically convert the file into the print data and/or to automatically transmit the print data, without a user command to perform the convert operation and/or the transmitting operation.

The application program unit 132 may control operations of the various stored application programs, and may process an interface for the application programs to be displayed on the user interface unit 120 so that a document to be printed may be written.

If a command to edit or store a document is input through the user interface unit 110, the application program unit 132 may read one or more pages to be converted from the document which is currently being processed, and may convert the read pages into a print file to be printed according to settings of the image forming apparatus 200 using the driver unit 133.

If a user desires to print the document generated using the application program, the driver unit 133 may convert the document into print data of a printable format. In this situation, the user may set print options required to perform printing using functions provided from the driver unit 133 or the application program. The print options may include a print range, the number of sheets to print, resolution or other options. The print options may be stored as the print profile.

If a certain event occurs, for example, if a command to open or store the file is input, if the file is edited, or if a preset period elapses, the processor 131 may control the application program unit 132 to convert the executed document into print data page by page using the driver unit 133 even before the print command is input.

The controller 130 may store the converted print data in the storage unit 140. Additionally, the controller 130 may control the interface unit 120 to request the image forming apparatus 200 to inform whether it is possible to receive the print data. If the image forming apparatus 200 is unable to receive the print data upon request of the interface unit 120, transmission of the print data converted page by page may be deferred. In more detail, if it is impossible to transmit the print data to the image forming apparatus 200 due to other tasks or transmission and reception from other terminal apparatuses, the controller 130 may wait until the print data may be transmitted to the image forming apparatus 200. If it is possible for the image forming apparatus 200 to receive the print data, the controller 130 may control the print data stored in the storage unit 140 to be transmitted.

If a file print command is input, the controller 130 may transmit to the image forming apparatus 200 a print command to print the file using the pre-transmitted print data at the time when the file print command is input. Specifically, if the print command is received, the controller 130 may determine whether the pre-transmitted print data exists in the image forming apparatus 200 page by page. If it is determined that prestored print data exists in the image forming apparatus 200, the controller 130 may transmit a command to print the prestored data to the image forming apparatus 200. If it is determined that the prestored print data does not exist in the image forming apparatus 200, the controller 130 may convert the corresponding page into print data and transmit the converted data to the image forming apparatus 200.

For example, if a user processes a document having a plurality of pages, that is, if a user edits a portion of the document, print data corresponding to unedited pages may already be stored in the image forming apparatus 200. Accordingly, in order to print the print data corresponding to unedited pages, the controller 130 may transfer the print command to the image forming apparatus 200. The print data corresponding to the partially edited pages may be converted as soon as the print command is applied, and the converted data may then be transmitted to the image forming apparatus 200. Therefore, the print data may be converted or transmitted page by page, so it is possible to process the print data separately.

Not only text documents but image, including tagged image file format (TIFF) files may also be converted and transmitted page by page. In this situation, each image or file in the set task folder of the user may be converted and transmitted page by page.

If the file is closed before the file print command is input, the controller 130 may cause a command to delete the pre-transmitted print data of the file to be transferred to the image forming apparatus 200. Specifically, if it is determined that there is no possibility to print the file converted into print data, the pre-transmitted print data may be deleted. For example, if a file currently edited is closed without requiring a separate printing operation, a user may delete data of the corresponding file stored in the image forming apparatus 200 and the terminal apparatus 100 if it is determined that the file has a low chance of being printed. Accordingly, storage space may be efficiently used.

FIG. 4 is a block diagram illustrating the image forming apparatus 200 according to an exemplary embodiment of the present general inventive concept.

The image forming apparatus 200 of FIG. 4 may receive the print data from the terminal apparatus 100, store the received data, and perform printing using the stored print data when the user enters the print command. For achieving this, the image forming apparatus 200 includes an interface unit 210, a storage unit 220, a controller 230, and a printing device 240 to print an image on a printing medium. A conventional printing device can be used the printing device 240. In this case, the conventional printing device is controlled by the controller 230 to perform printing the received print data according the present general inventive concept.

The stand-by state of the printing device 240 may be a state when the print data is received and stored and when a command to print the received print data is not received. That is, the printing device 240 may prepare a feeding operation to feed a printing medium toward a printing unit, for example, an inkjet head unit or an electrostatic image forming unit. The printing device 240 may prepare a printing operation to control the printing unit to perform a printing without delay or a waiting period taken to receive the print data from the terminal apparatus 100.

The interface unit 210 may be connected to the terminal apparatus 100, and may receive the print data and the print command from the terminal apparatus 100. Additionally, the interface unit 210 enables the image forming apparatus 200 to be connected to an external apparatus, for example, the terminal apparatus 100, and may be implemented as a parallel port, a USB port or a wireless module. If a computer is used as the terminal apparatus 100, the interface unit 210 may receive a document created by the computer and converted into languages which the image forming apparatus 200 is able to interpret.

The storage unit 220 may store the print data, which is converted page by page and transmitted from the terminal apparatus 100. Specifically, the received print data, that is, output data of the document to be printed may be sequentially stored in a unit of page, that is, page by page. For example, if a currently processed document includes three pages, “Text.1page.prn”, “Text.2page.prn” and “Text.3page.prn” may be sequentially stored.

The storage unit 220 may be a built-in memory in the image forming apparatus 200, for example, a read only memory (ROM), a flash memory or a hard disk memory (HDD). Additionally, the storage unit 220 may also be an external HDD or a memory card which is connected to the image forming apparatus 200, for example a flash memory, such as a memory stick (MS), xD or SD, or a USB memory.

If the file print command is received through the interface unit 210, the controller 230 may control the file to be printed using the prestored print data. Additionally, if a command to delete the prestored print data of the file is received from the terminal apparatus 100, the controller 230 may control the storage unit 220 so that the print data stored in the storage unit 220 is deleted. Furthermore, if the print data corresponding to the edited portions of the file is received from the terminal apparatus 100, the controller 230 may also control the storage unit 220 so that the print data stored in the storage unit 220 may be updated with the print data corresponding to the edited portions. For example, if the storage unit 220 contains three pages of print data, if a second page is edited, and if print data “Text.2page.prn” corresponding to the second page is received from the terminal apparatus 100, the controller 230 may cause the print data “Text.2page.prn” to be updated with the edited second page.

If the terminal apparatus 100 inquires whether the image forming apparatus 200 is able to receive the print data, the controller 230 may check whether the image forming apparatus 200 communicates with another terminal apparatus, and may determine whether there is a possibility to receive the print data, based on a result of checking. Specifically, the controller 230 may control the interface unit 210 to notify that the image forming apparatus 200 is unable to receive the print data because communication with another terminal apparatus is being performed. If it is determined that the image forming apparatus 200 is able to receive the print data, the controller 230 may control the interface unit 210 to notify that it is possible to receive the print data, and may then prepare for the receipt of the print data. The image forming apparatus 200 may be connected to a plurality of terminal apparatus, and may also be connected to a network to perform printing. Accordingly, the possibility of transmission and reception of data may be checked using connections or communications with the terminal apparatuses, so it is possible to effectively manage resources of the image forming apparatus 200.

The image forming apparatus 200 may receive not only the print command but also additional print profile information, to convert the prestored print data. In more detail, if the user uses print options and zoom-in and out functions in order to print several pages on a single print sheet, the image forming apparatus 200 may convert several pages into print data and print the converted print data using the print profile information contained therein without receiving separately converted data.

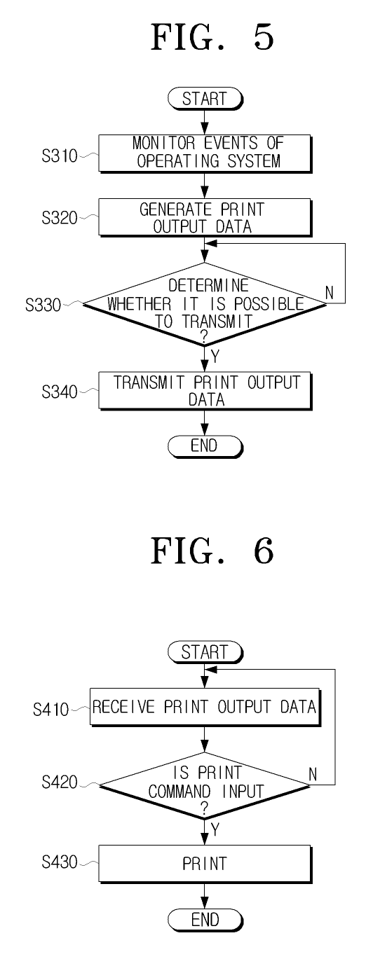

FIG. 5 is a flowchart illustrating a print file management method according to an exemplary embodiment of the present general inventive concept.

According to the print file management method illustrated in FIG. 5, the terminal apparatus 100 may monitor the events of the operating system, and may determine whether the word processor used to edit a document file is executed in operation S310. If the word processor is executed to create and edit the original document, the created document may be converted into print data page by page in operation S320. Specifically, if the original document is opened or is being edited, a user may determine that the document is which is highly likely to be printed later, and the document which is open or is being edited may then be converted. Additionally, the user may process a plurality of documents at the same time, so it is possible to convert the plurality of documents being processed.

If the print data is generated, the terminal apparatus 100 may determine whether it is possible to transmit the print data to the image forming apparatus 200 in operation S330. Specifically, after completion of conversion, the terminal apparatus 100 may transmit the number of pages of the converted print data and the completely converted data to the image forming apparatus 200, and may inquire whether the image forming apparatus 200 is able to receive the print data. In response to the inquiry of the terminal apparatus 100, the image forming apparatus 200 may notify that it is possible to print the print data, or that it is ready to print the print data.

If it is determined that it is possible to transmit the print data, the terminal apparatus 100 may transmit the converted print data in operation S340. In more detail, the print data converted page by page may be individually transmitted, and if only a portion of print data is converted, only the converted data may be transmitted.

FIG. 6 is a flowchart illustrating a printing method according to an exemplary embodiment of the present general inventive concept.

According to the printing method of FIG. 6, the image forming apparatus 200 may receive the print data converted page by page from the terminal apparatus 100 before the print command is received, in operation S410. Next, the user may apply the print command in operation S420.

If the print command is applied, printing may start using the prestored print data of the file in operation S430. Accordingly, after the user enters the print command, operations of converting the file into print data which the image forming apparatus 200 is able to interpret and of transmitting the converted data may be performed during the operation by which the user edits the document, so the printing speed may increase.

Table 1 shows a result of measuring time required to perform operations by which a user edits a document and enters the print command, and of completing printing, in order to compare the printing speed of the conventional printing method to that of the printing method according to the present general inventive concept.

TABLE 1

| | | Present general |
|---|---|---|
| | Conventional art | inventive concept |
| Simple file | 10.13 seconds | 8.33 seconds |
| Complicated file | 26.01 seconds | 11.51 seconds |

In the case of the simple file illustrated in Table 1, the result values were obtained by inputting letters, for example “test”, and measuring time required for printing. Additionally, in the case of the complicated file illustrated in Table 1, the result values were obtained using a file having a capacity of approximately 5920 KB to measure the printing speed. Therefore, in the present general inventive concept, even when the simple file was printed, the printing time was reduced, and when the complicated file having a large capacity was printed, the printing time was remarkably reduced by at least half, compared with the conventional printing method.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the present general inventive concept provides that a user prepares a document which is highly likely to be printed, so that a print delay time may be reduced and a printing speed may increase. Additionally, resources of an image forming apparatus may be efficiently managed by checking the transmission status between a terminal apparatus and the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A terminal apparatus comprising:
an interface unit connected to an image forming apparatus; and
a controller to convert a file into print data page by page before a file print command is input and to transmit the converted print data to the image forming apparatus when a preset event occurs in the file.

2. The apparatus of claim 1, wherein, if the file print command is input, the controller causes the image forming apparatus to perform printing using the pre-transmitted print data.

3. The apparatus of claim 1, wherein the controller checks whether the image forming apparatus is able to receive the print data.

4. The apparatus of claim 3, further comprising a storage unit,
wherein if it is determined that the image forming apparatus is unable to receive the print data, the controller stores the print data converted page by page in the storage unit.

5. The apparatus of claim 1, wherein, if the file is closed before the file print command is input, the controller causes the image forming apparatus to remove the pre-transmitted print data of the file.

6. The apparatus of claim 1, wherein, if the file is edited before the file print command is input, the controller converts an edited portion of the file into print data and transmits the converted data to the image forming apparatus.

7. An image forming apparatus comprising:
an interface unit connected to a terminal apparatus;
a storage unit to store print data, which is converted page by page from a file and is transmitted from the terminal apparatus; and
a controller to cause the prestored print data of the file to be printed, if a file print command is received via the interface unit.

8. The apparatus of claim 7, wherein, if the terminal apparatus inquires whether the image forming apparatus is able to receive the print data, the controller notifies the terminal apparatus of the possibility to receive the print data.

9. The apparatus of claim 7, wherein, if a command to delete the prestored print data of the file is received from the terminal apparatus, or if the preset time has elapsed after the print data of the file is stored in the storage unit, the controller deletes the print data stored in the storage unit.

10. The apparatus of claim 7, wherein, if print data corresponding to an edited portion of the file is received from the terminal apparatus, the controller updates the print data corresponding to the edited portion from among the print data stored in the storage unit.

11. A printing system comprising:
a terminal apparatus to convert a file into print data page by page before a file print command is input and to transmit the converted print data to an image forming apparatus when a preset event occurs in the file; and
an image forming apparatus to receive the print data from the terminal apparatus and to store the received print data, and to perform printing using the prestored print data of the file if the file print command is input.

12. A printing method in a terminal apparatus, the method comprising:
determining whether a preset event occurs in a file;
if it is determined that the preset event occurs in the file, converting the file into print data page by page before a file print command is input; and
transmitting the converted print data to an image forming apparatus.

13. The method of claim 12, further comprising:
if the file print command is input, causing the image forming apparatus to perform printing using the pre-transmitted print data.

14. The method of claim 12, further comprising:
checking whether the image forming apparatus is able to receive the print data.

15. The method of claim 12, further comprising:
if the file is closed before the file print command is input, causing the image forming apparatus to remove the pre-transmitted print data of the file.

16. The method of claim 12, further comprising:
if the file is edited before the file print command is input, converting an edited portion of the file into print data and transmitting the converted data to the image forming apparatus.

17. A printing method in an image forming apparatus, the method comprising:
receiving print data converted page by page from a file from a terminal apparatus and storing the received print data; and
if a file print command is received from the terminal apparatus, printing the prestored print data of the file.

18. The method of claim 17, further comprising:
if the terminal apparatus inquires whether the image forming apparatus is able to receive the print data, notifying the terminal apparatus of the possibility to receive the print data.

19. The method of claim 17, further comprising:
if a command to delete the prestored print data of the file is received from the terminal apparatus, or if the preset time has elapsed after the print data of the file is stored in the storage unit, deleting the print data stored in the storage unit.

20. The method of claim 17, further comprising:
if print data corresponding to an edited portion of the file is received from the terminal apparatus, updating the print data corresponding to the edited portion from among the print data stored in the storage unit.

21. A computer-readable medium to contain computer-readable codes as a program to execute a printing method in a printing system having a terminal apparatus, the method comprising:
determining whether a preset event occurs in a file;
if it is determined that the preset event occurs in the file, converting the file into print data page by page before a file print command is input; and
transmitting the converted print data to an image forming apparatus

22. A computer-readable medium to contain computer-readable codes as a program to execute a printing method in a printing system having an image forming apparatus, the method comprising:
receiving print data converted page by page from a file from a terminal apparatus and storing the received print data; and
if a file print command is received from the terminal apparatus, printing the prestored print data of the file.

23. A printing system comprising:
a terminal apparatus having a controller to automatically convert a file into print data and to transmit the converted print data to an external apparatus, without a file print command when a preset event occurs in the file.

24. A printing system comprising:
an image forming apparatus having a storage unit, and a controller to receive print data without a file print command, to control the storage unit to store the received print data, and to print the stored print data when the file print command is received.

25. A printing system comprising:
a terminal apparatus having a controller to automatically convert a portion of a file into print data and to transmit the converted print data to an external apparatus, without converting an entire portion of the file into entire print data and transmitting the entire print data of the file, when a preset event occurs in the portion of the file.

26. A printing system comprising:
an image forming apparatus having a storage unit, and a controller to control the storage unit to store print data of an entire portion of the file, to receive another print data of a portion of the file, and to update the stored print data of the entire portion of the file with the another print data of the portion of the file.

27. A printing system comprising:
an image forming apparatus having a controller to separately receive first print data of an entire portion of the file, second print data of a portion of the file, and a file print command, and to print an image according to the first print data of the entire portion of the file and the second print data of the portion of the file when the file print command is received.

28. A printing system comprising:
a terminal apparatus having a controller to convert a file into print data and to transmit the converted print data to an external apparatus, when a preset event occurs in the file, and to transmit a file print command separately from the converted print data.

29. A printing system comprising:
an image forming apparatus having a controller to separately receive print data and a file print command at a time interval, and to print the print data according to the separately received file print command.

30. A printing system comprising:
an image forming apparatus having a storage unit, and a controller to receive print data without a file print command, to control the storage unit to store the received print data, and to print the stored print data when the file print command is received.

31. A printing system comprising:
a terminal apparatus having a controller to convert one of a plurality of units of a file into print data and to transmit the print data to an external apparatus, when a preset event occurs in the one unit of the file, and to transmit a file print command separately from the print data to print the file with the transmitted print data.

32. A printing system comprising:
a terminal apparatus having a controller to convert a first unit of a file into first print data and to transmit the first print data to an external apparatus when a preset event occurs in the first unit of the file, to convert a second unit of the file into second print data and to transmit the second print data when a second preset event occurs in the second unit of the file, and to generate a file print command to print the file using the first print data and the second print data.

33. A printing system comprising:
an image forming apparatus having a controller to receive first print data corresponding to a first unit of a file from an external apparatus, to separately receive second print data corresponding to a second unit of the file, and to receive a file print command.

34. The printing system of claim 33, wherein the image forming apparatus comprises a storage unit to store the file and to update the file with the first print data and the second print data, and the controller to print an image corresponding to the updated file according to the file print command.

35. The printing system of claim 33, wherein the image forming apparatus comprises a printing device to be in a stand-by state to prepare a printing operation when the controller receives at least one of the first print data and the second print data.

36. The printing system of claim 35, wherein the printing device is changed from the stand-by state to the printing operation when the controller receives the file print command.

37. The printing system of claim 35, wherein the printing device perform the printing operation when the controller receives the file print command.

38. The printing system of claim 33, wherein the file comprises a plurality of units including the first unit and the second unit, and one or more remaining units of the file are not received when the first print data and the second print data are received.

39. The printing system of claim 33, wherein the first unit of the file comprises a page of the file, and the second unit of the file comprises another page of the file.

40. A printing system comprising:
an image forming apparatus connectable with a first terminal apparatus and a second terminal apparatus to receive first print data of a first file without a first file print command from the first terminal apparatus, to receive second print data of a second file without a second file command from the second terminal apparatus, and to print an image corresponding to one of the first file and the second file according to a corresponding one of the first file print command and the second file print command.
